(19) United States
(12) Patent Application Publication
(10) Pub. No.: US 2011/0267735 A1
(43) Pub. Date: Nov. 3, 2011

(54) ELECTROSTATIC DISCHARGE CHAIR WITH A GROUNDING DISC

(76) Inventor: Kek Hing Kow, Beranang (MY)

(21) Appl. No.: 13/142,841

(22) PCT Filed: Dec. 31, 2008
(86) PCT No.: PCT/MY08/00198

§ 371 Date: Jun. 29, 2011

(51) Int. Cl. H05F 3/02

(52) U.S. Cl. 361/220

(57) ABSTRACT

Electrostatic discharge chair with a grounding disc suitable to be used on a swivel chair are described. The accessories comprise a static dissipative chair cover (12), flexible conductive ground loop (14) and grounding means (16). The flexible conductive ground loop (14) have an attaching means (24) attached with two flexible coiled springs, the first spring having an open end (26a) and the second spring having an open tapered (26b) end. The flexible conductive ground loop (14) is attached to chair cover (12) and wrapped around swivel post (34) by screwing one end of the spring into the other to provide a ground path from chair cover to swivel post. The grounding means (16) is attached to swivel post and in contact with ground to provide a ground path from swivel post to ground.

The present invention relates generally to electrostatic control device, more particularly to grounding device for dissipating electrostatic charges accumulated on a chair.

### BACKGROUND OF THE INVENTION

Electrostatic is an electrical charge at rest created mainly by friction of movement causing an imbalance of electrons. The magnitude of static electricity depends on factors such as the type of material, speed of separation, contact pressure, and relative humidity of the environment. The sudden discharge of static is called an electrostatic discharge. Some electronic device cannot withstand electric spark discharge which may permanently damage the device. As more transistors are crammed into electronic device, the more fragile the device behaves towards electrostatic spark.

Care is taken in manufacturing and handling of electrostatic discharge sensitive components to reduce, or hopefully eliminate static electricity. People, equipments and materials have to be properly grounded to discharge harmful static charge that may reside on every people, equipments or materials.

Chairs are a common item used in a manufacturing facility. The movement of human on a chair can cause static electricity to discharge and damage electronic components.

An electrostatic discharge chair can help in eliminating static electricity to protect electrostatic discharge sensitive devices. U.S. Pat. No. 4,630,867 describes an electrostatic dissipative chair having a non-conductive chair cover and a conductive flexible mesh to dissipate static charge. The mesh is incorporated between chair cover and chair cushion. Means are utilized to dissipate static charge from the mesh to ground.

EP patent 1335639 describes an electrostatic chair suitable for being used in places where there is radiation or electromagnetic field to which a human operator is being exposed. The chair is characterized in that the chair can absorb the electrostatic charge deposited on the body of the operator sitting down and discharges them to ground. The seat is made up of electrostatic discharge surface finishing having metallic threads.

A typical electrostatic discharge chair consists of an electrostatic discharge seating, electrically connected to a metal swivel post, extending downwards through the main metal swivel post to a plurality of radially spread out metallic legs. Each leg is fixed with a conductive or static dissipative swivel castor to allow static charge dissipation to ground and allow free movement of the chair on the floor.

Those skilled in the art have developed the idea of a detachable electrostatic discharge chair cover having a coiled ground cord to be connected to a grounding point. Yet another skilled in the art developed another electrostatic discharge chair cover having a drop chain resting on the floor. Static charge can flow from a person's body sitting on the electrostatic chair cover through the coiled drop chain to ground.

However, the cost of a properly designed electrostatic discharge chair can be prohibitive when considering a large scale implementation in a typical labour intensive electronics assembly operation. An alternative to a costly large scale implementation of electrostatic discharge chairs is the use of detachable electrostatic discharge chair covers. A detachable electrostatic discharge chair cover with a standard grounding means is relatively low cost. Standard grounding means are usually metal drag chain with one end attached to an electrostatic discharge chair cover and the other end dropping on the floor. An alternative method is to use a ground cord with one end attached to an electrostatic discharge chair cover and the other end connected to the adjacent electrostatic discharge work table.

Drag chains have little contact with floor in reality and become disconnected with ground especially on patterned conductive tile or patterned static dissipative tile. Furthermore, the chain may obstruct the movement of human or jamming the chair when the seat spins during the adjustment of the chair's height.

For the coiled ground cord design, when the chair seat turns one or more full circle, the ground cords can also strangle itself to the swivel post of the chair. This will become a problem because this will result not only in the sudden ejection of the banana plug of coiled ground cord which was earlier plugged into the outlet socket usually at the front or side panel just beneath the surface of the table, it can also cause danger to the person who sits on the chair with a bunch of strangled coiled cord underneath the seat of the chair.

Ordinary people skilled in the art would prevent the full-circle turning of the chair seat by connecting a wire at one end at a point along the perimeter of the seat located right below the back rest and the other point at one of the legs of the chair base positioned vertically below the back rest. However such connecting means is clumsy and look unsightly. It can also en-danger any passing-by object that may accidentally hit on the connecting wire thereby causing accidental fall of people or the damage of fallen objects.

Further investigation and research is undertaken in seeking a more practical and reliable solution to achieve good and cost-effect practical utility.

### SUMMARY OF THE INVENTION

It is therefore the primary objective of the present invention to research and find a practical and workable means that can provide a cost effective alternative to an electrostatic discharge chair that make it possible for a wide scale application in the electrostatic discharge sensitive electronic manufacturing activities.

The invention disclosed herewith consists of a conductive or static dissipative chair cover, a unique flexible conductive ground loop and a grounding means to be used on a typical swivel chair. Static charge flows from the chair cover to the flexible conductive ground loop. The conductive ground loop conducts the static charge to the swivel post. The grounding means is used to drain static charge from the swivel post to ground.

The flexible conductive ground loop provides a means to drain static charge from the chair cover to the swivel post seamlessly without any loose or hanging parts. Loose or hanging parts resulted from the use of a normal coiled ground cord or drag chain used in prior art are cumbersome and ineffective.

### BRIEF DESCRIPTION OF THE DRAWINGS

The invention will now be described in greater detail, by way of an example, with reference to the accompanying drawings, in which:

FIG. 1 illustrates a perspective view of an embodiment of electrostatic dissipative chair cover with a ground disc on a swivel chair;

FIGS. 2A and 2B illustrate a perspective view of a flexible conductive ground loop;

FIG. 3 illustrates a rear bottom view of a swivel chair showing the seamless integration of flexible conductive ground loop on the swivel post;

FIGS. 4A and 4B illustrates a bottom view of a swivel chair depicted in FIG. 3, showing the clutter free integration of flexible conductive ground loop on the swivel post in two varying degree; and

FIG. 5 illustrates a perspective view of a grounding means chained to a swivel chair.

### DETAILED DESCRIPTION OF THE DRAWINGS

An overview of an embodiment of electrostatic discharge chair cover with a grounding disc will first be described according to FIG. 1, showing a dissipative chair cover (12), flexible conductive ground loop (14) and grounding means (16). The dissipative chair cover (12) is preferably a detachable static dissipative chair cover. The accessories are desired to be used on a typical swivel chair (17) which swivels around a swivel post (34).

The detachable chair cover (12) is made of static dissipative material. It is used to cover the back rest (18) and seat (20) of a chair. A conductive or static dissipative strip (22) is used to maintain contact between back rest and seat to dissipate static from the back rest to the seat of the chair.

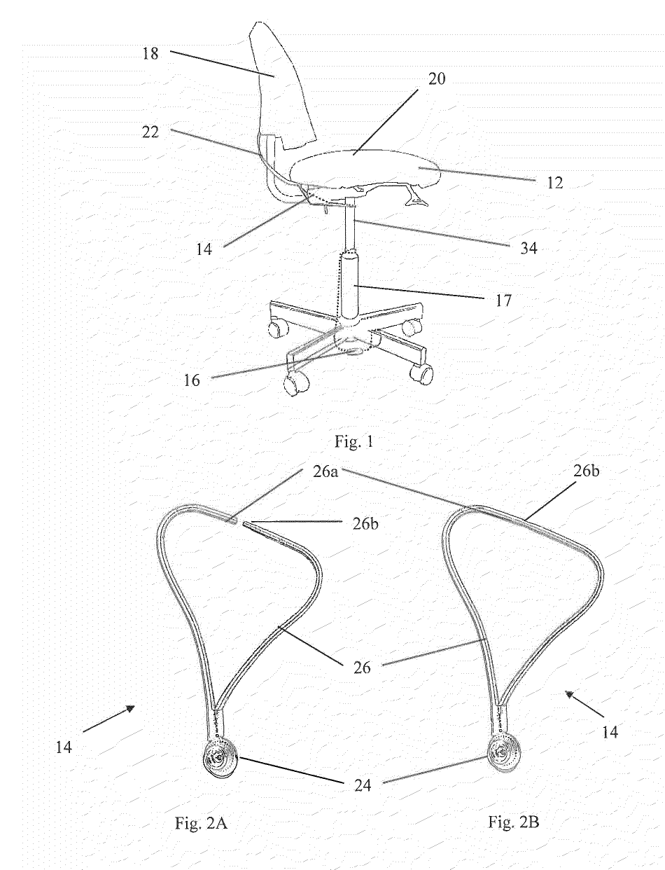

The flexible conductive ground loop (14) comprises of an attaching means (24) and a pair of coiled springs (26), as shown in FIG. 2A. A snap fastener is preferably used as attaching means (24). The coiled springs are affixed to the attaching means. The first spring have an open end (26a). The second spring has an open tapered end (26b). The open end (26a) and open taper end (26b) are to be fastened together as interlocking loops by screwing one end into the other, as shown in FIG. 2B. The interlocking mechanism of the ends is similar to Garter springs.

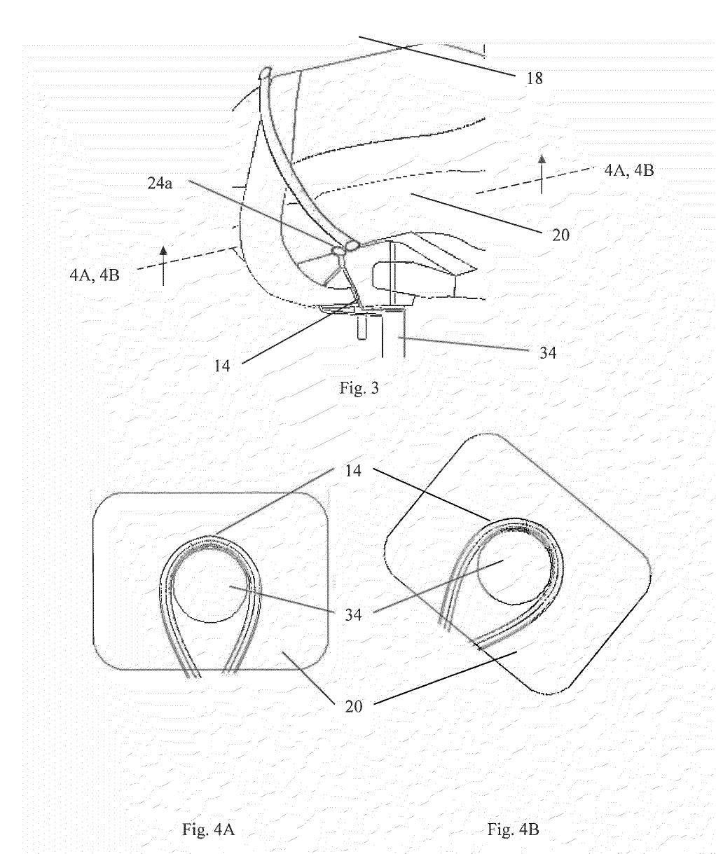

The flexible conductive ground loop (14) is attached to the seat cover (20) on a chair through a snap fastener (24a) as shown in FIG. 3. The flexible coiled springs are wrapped around the swivel post (34) of the chair. It is the use of this flexible conductive ground loop which transfers static charge from the seat cover to the swivel post. The swivel post is made of conductive material.

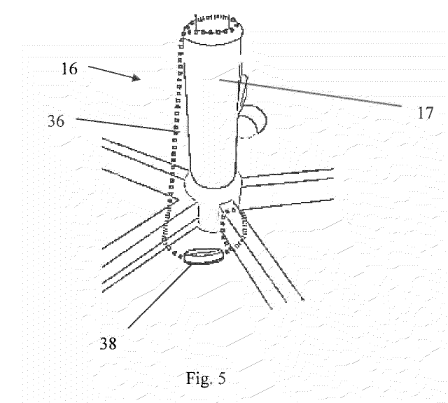

The use of flexible conductive ground loop (14) provides a clutter free method to transfer static charge from chair cover (12) to the swivel post (34). The flexible conductive ground loop does not impede the movement of the chair to swivel in any direction, as shown in FIGS. 4A and 4B. When the seat of the chair swivels, the flexible conductive ground loop follows the direction of swivel while maintaining good contact with the swivel post. The good contact allows static charge to be reliably discharged from the metallic swivel post. The chair can make a number of full-circle turns on the swivel post while maintaining clutter free appearance.

FIG. 5 shows a grounding means (16) which transfers static charge from the swivel post to ground. The grounding means (16) is preferably comprises of a conductive strip (36) and a grounding weight (38). The conductive strip (36) is wrapped around the lower part of the swivel post (34), extending downwards and attached to the weight below. The grounding weight (38) has a relatively large contact area and considerable mass to ensure good contact with ground to reliably transfer static electricity to ground. The conductive strip (36) acts as a medium to allow transfer of static electricity from swivel post (34) to weight (38). Any material which transfers static electricity can be used as conductive strip. Metal chain, metal wire, metal spring or braided metal wire make a good conductive strip. Other form of grounding means may be used, such as simple drag chains.

The weight (38) has pitched edges and two conductive strips (36). The pitched edges are pitched at an angle of 20 degree to 40 degree. A weight with two conductive strips spaced apart attached to the weight will facilitate a more stable movement of the weight compared to the attachment of having only one conductive strip. Thus forward, backward, left and right movement of the chair will not cause the weight to move relentlessly when it is connected with two conductive strips spaced apart. Two conductive strips will also provide better grounding durability because if one strip breaks, another strip will still be dissipating static electricity.

Static charge created by the movement of human on a swivel chair is transferred from chair cover (12) to flexible conductive ground loop (14), swivel post (34), and grounding means (16). The combination of these accessories provides a clutter free and seamless integration of useful grounding device for a swivel chair without impeding the free movement of the chair.

When the chair seat turns 360°, the electrical contact between the flexible coiled loop and the swivel post remained intact as the gravitational weight and its light tension coiled spring of the flexible conductive loop remains consistent and unchanged. Repeatedly making 360° turning of the chair seat would not affect the electrical continuity between the flexible conductive loop and the swivel post. Such unique method of placement of the conductive loop achieves permanent fool-proof electrical contact integrity without any mechanical fastening.

At the lower end of the exposed metal post, the conductive strip is wrapping around it and forming a loop. The strip extends itself and attaches to a grounding weight which is resting on a static dissipative or conductive floor.

This will enable a person who sits on the electrostatic discharge chair cover to effectively conduct and dissipate the static charge from his body through the conductive loop, swivel post, conductive strip and the grounding weight to the conductive floor with good electrical continuity. Such design will effectively drain away the harmful static charge on the worker sitting on the electrostatic discharge chair cover thereby protecting the electrostatic sensitive electronic devices from any electrostatic discharge damage.

Accordingly, the invention has a simple setup of grounding a chair with electrostatic grounding discharge accessories. It is the combination of the above features and its technical advantages give rise to the uniqueness of such invention. Although the descriptions above contain much specificity, these should not be construed as limiting the scope of the embodiment but as merely providing illustrations of some of the presently preferred embodiments.

1. Electrostatic discharge chair accessories suitable to be used on a swivel chair comprising:
a static dissipative chair cover (12);
a flexible conductive ground loop (14); and
a grounding means (16);
wherein the flexible conductive ground loop (14) is attached to chair cover (12) and wrapped around swivel post (34), and grounding means (16) is attached to swivel post and in contact with ground to provide a ground path from swivel post to ground;
whereby the electrostatic chair accessories dissipate static electricity from a swivel chair via dissipative chair cover and flexible conductive ground loop to swivel post, and from swivel post to ground via grounding means.

2. Electrostatic discharge chair accessories according to claim 1, wherein the chair cover (12) is preferably a detachable static dissipative chair cover.

3. Electrostatic discharge chair accessories according to claim 1, wherein the chair cover (12) preferably covers the seat (20).

4. Electrostatic discharge chair accessories according to claim 1, wherein the chair cover (12) preferably covers the seat (20), while a dissipative strip (22) maintains contact between back rest and seat to dissipate static from the back rest to the seat.

5. Electrostatic discharge chair accessories according to claim 1, wherein the flexible conductive ground loop (14) has an attaching means (24) attached with a pair of flexible coiled springs, the first coiled spring having an open end (26a) and the second spring having an open tapered (26b) end.

6. Electrostatic discharge chair accessories according to claim 4, wherein the flexible conductive ground loop (14) is wrapped around swivel post (34) by screwing one end of the spring into the other to provide a ground path from chair cover to swivel post.

7. Electrostatic discharge chair accessories according to claim 4, wherein the attaching means (24) is preferably a snap fastener.

8. Electrostatic discharge chair accessories according to claim 1, wherein the grounding means (16) preferably comprises of a conductive strip (36) and a conductive weight (38).

9. Electrostatic discharge chair accessories according to claim 8, wherein the weight is pitched having pitched edges at an angle of 20 degree to 40 degree.

10. Electrostatic discharge chair accessories according to claim 8, wherein the weight (38) is connected with two conductive strips (36) dragged to a swivel chair.
